(19) United States
(12) Patent Application Publication
(10) Pub. No.: US 2002/0004780 A1
(43) Pub. Date: Jan. 10, 2002

(54) On-line transaction system, transaction method for on-line shopping, and server and vender terminals

(76) Inventor: Hideyuki Mizuta, Yamato-shi (JP)

Correspondence Address: PERMAN & GREEN, 425 POST ROAD, FAIRFIELD, CT, 06430, US

(21) Appl. No.: 09/822,677

(22) Filed: Mar. 30, 2001

(30) Foreign Application Priority Data
Mar. 30, 2000 (JP) 2000095462

(51) Int. Cl. G06F 17/60

(52) U.S. Cl. 705/39; 705/26

(57) ABSTRACT

A money transfer system that a consumer and an on-line shop can safely rely on to perform a transaction involving a predetermined amount of money, without requiring the intervention of a third party and by employing the same procedures as are used for an on-line money transfer. When a dedicated account is temporarily opened to pay for a purchase and a vender and a buyer mutually lock on to the account, safe payment method and apparatus, including monetary security, is provided as an on-line bank function. An on-line purchase payment transaction system is established for the use, via a network 14, of a vender (Seller) 13 and a user (Buyer) 11 of goods, whereby to pay for goods the user requests that a financial institution 12 prepare a temporary account for a designated transaction, the user 11 issues an instruction to deposit money in the temporary account, and locks the temporary account to limit access by the vendor 13; and whereby the seller 13, via the network 14, verifies the contents of the temporary account and locks the temporary account to limit access by the user 11.

### FIELD OF THE INVENTION

The present invention relates to a system for enabling on-line shopping using the Internet, and more particularly, to an on-line system that smoothly transfers money on line.

### BACKGROUND ART

Currently, electronic commerce (EC), constituting on-line business transactions performed using the Internet, has drawn great attention. For example, in a virtual shop, first, on the homepage of the shop, a user selects a desired goods from a page in an “electronic catalog” that includes goods images and descriptions. Then, when the user clicks on a “purchase” button for desired goods or a desired item, an order form is brought for entry by the user of a delivery address and other required personal information. In addition to the address, the user enters his or her name, and a payment method (bank money transfer, postal money order, cash on delivery, or credit card), and completes the purchase by clicking on a submission button to transfer the data to the seller.

While selecting goods at virtual shops is inferior to the act of selecting items using printed paper catalogs, which may provide views of all available goods, electronic commerce systems show great promise in that they provide search functions that can be used to sift through enormous amounts of data, and thus permit buyers to quickly make decisions based on the very latest information. Further, since electronic commerce procedures are very convenient, they are especially effective for transactions, such as making flight reservations, that must be concluded rapidly. As is explained above, on-line shopping systems enable consumers to make purchases based on the latest information, while not having to leave their homes. In addition, on-line shopping systems also enable vendors to tap wide ranging pools of consumers, unhindered by geographic limitations, without having to invest in, and thus incur large expenses, for the equipment required for retail establishments, such as stores, and to reduce the costly labor and fees involved in the physical distribution of catalogs. Thus, on-line shopping systems are highly beneficial to both consumers and vendors.

However, on-line shopping using the Internet has been slow to catch on in some countries such as Japan. One of the reasons is the lack of confidence buyers have in the available payment methods. Currently, for on-line shopping a consumer may employ bank money transfers, COD (cash on delivery) transactions, or credit cards. However, for a bank money transfer a user must remit money before goods that were ordered are received, the user is always unsure of the status of a transaction. Further, a COD transaction is often not a very convenient procedure for a user, since the user must remain at home until an order is delivered. And as for a payment effected using a credit card, since the important information relative to the use of a personal credit card must be transmitted across a network, a third party may “pretend to be” or impersonate a legitimate card holder. And even if adequate security is provided for the transmission of data across the Internet, the transmission path, an electronic shop that receives the credit card information may use it illegally. As a result, because of security and other uncertainties users tend to hesitate to do their shopping on-line.

To resolve the problems associated with these transaction methods, a system has been devised that provides for the transfer of money through a third party. According to this system, a consumer remits funds to a specified agent by using a credit card or a bank transfer, and a vender receives payment for an order after it has been shipped. However, according to this system, since the user transfers funds to an agent, the time required for a transaction is doubled. And further, there is an increased commission fee, the registration process is troublesome, and personal information must be entrusted to the agent. As a result, this system is not an appropriately credible system, and a strong demand has arisen for a system that permits a consumer to safely and easily transfer money on line via a reliable bank or another financial organization.

### SUMMARY OF THE INVENTION

To resolve the above shortcomings, it is one object of the present invention to provide, for electronic commerce, means for the easy and secure remittance of funds tendered as payment for a purchase.

It is another object of the present invention to provide a money transfer system that a consumer and a vendor can safely rely on to perform a transaction involving a predetermined amount of money, without requiring the intervention of a third party and by employing the same procedures as are used for an on-line money transfer.

To achieve the above objects, when a dedicated account is temporarily opened to pay for a purchase and a vender and a buyer alternately lock on to the account, safe payment means, including monetary security, is easily provided as an on-line bank function. That is, in accordance with the present invention, an on-line purchase payment transaction system is established for the use, via a network, of a vender and a purchaser of goods, whereby to pay for an item or for goods, the purchaser requests that a financial institution prepare a temporary account for a designated transaction, the user issues an instruction to deposit money in the temporary account, and locks the temporary account to limit access by the vendor; and whereby the vendor, via the network, verifies the contents of the temporary account and locks the temporary account to limit access by the purchaser.

The vender, after locking the temporary account to limit access by the purchaser, then ships the goods. Thus, the money can be held in the temporary account while access by the purchaser is limited, and the state under which the goods is shipped is secure. Further, when the vender has verified that the temporary account has been unlocked by the purchaser, the vender can move the money deposited in the temporary account.

The present invention is not limited to the sale of goods, but can be applied for other, more general types of transactions. That is, in accordance with the present invention, an on-line transaction system can be set up between a first user and a second user and operated via a network whereby to pay for goods. The first user requests that a financial institution prepare a temporary account for a designated transaction, the first user issues an instruction to deposit money in the temporary account, and locks the temporary account to limit access by the second user; and whereby the second user, via the network, verifies the contents of the temporary account and locks the temporary account to limit access by the first user.

According to the present invention, a transaction method, which is employed for on-line shopping, performed via a network, by the vendor and the purchaser of goods, is provided whereby the purchaser employs a first key, which is held at a financial institution and which only the purchaser can access, to place a first lock on money held by the financial institution for purchasing the goods; whereby the vendor employs a second key, which is held at the financial institution and which only the vendor can access, to place a second lock on the money; and whereby when the first key is employed to place a first lock on the money the vendor can not move the money and when the second key is employed to place a second lock on the money the purchaser can not move the money.

The money held by the financial institution is deposited in a temporary, dedicated account opened for the remittance of a payment, and the first key and the second key are employed to lock the temporary account.

The financial institution transmits a setup screen for a temporary account to the purchaser, and, in accordance with the setup screen, the purchaser transfers money, for a business transaction, for deposit in the temporary account; issues a request to the financial institution to set up the temporary account; and as needed, transmits a request to the financial institution to use the first key to place a lock on the temporary account. Thereafter, the financial institution transmits a setup screen for the temporary account to the vendor, and receives from the vendor a request to use the second key to place a lock on the temporary account as needed.

Subsequently, the vendor, after using the second key to place a lock on the money, ships goods to the purchaser, and thereafter, the purchaser uses the first key to remove the first lock on the money in order to pay the vendor. In accordance with this configuration, designated limitations are placed on a common bank money transfer procedure, and the money that is transferred, instead of being immediately moved, is regarded as a deposit. Such operations can be easily performed on line.

According to the present invention, a transaction method for on-line shopping performed between a vender and a purchaser via a network, comprises the steps of: preparing a temporary account, one of which is designated for each transaction, upon the receipt of an on-line instruction from the purchaser; receiving an on-line instruction from the purchaser to deposit money in the temporary account; moving the money from the temporary account upon the receipt of an on-line instruction from the vender; and automatically erasing the temporary account after the money has been moved.

The temporary account is locked on-line by the purchaser using a key therefor, and the temporary account is also locked on-line by the vendor using a key therefor. When the temporary account is locked using the key belonging to the purchaser, money held in the temporary account can not be moved by the vendor, and when the temporary account is locked using the key belonging to the vendor, money held in the temporary account can not be moved by the purchaser. Since the vender and the purchaser alternately lock the account, a money transfer system can be provided that both a consumer and an on-line shop can safely employ by using the same procedures required for an on-line money transfer, and without a third party being needed.

According to another aspect of the invention, a server, which is connected to a network and which serves as an on-line bank for on-line shopping transactions, comprises: a reception unit for receiving a request, from a terminal of a purchaser connected to the network, for the preparation of a temporary account used for an on-line shopping payment, and for receiving information concerning money that should be deposited in the temporary account; a temporary account generator for generating the temporary account based on the request and on the money information that is received; a storage unit for storing information concerning the temporary account; a key information reception unit for receiving, from the terminal of the purchaser, purchaser key information for the inhibition of the transfer of money in the temporary account by a party other than the purchaser, and for receiving, from a terminal of a vendor connected to the network, vendor key information for the inhibition of the transfer of money in the temporary account by a party other than the vendor; and a temporary account locking unit for employing the purchaser key information and the vendor key information to change information, stored in the storage unit, concerning the locked state of the temporary account.

The server further comprises: a transmission unit for storing in the storage unit, in addition to the information concerning the temporary account, a change in the state of the temporary account for which a lock is applied by the temporary account locking unit, and for transmitting the information stored in the storage unit for the temporary account. This arrangement is preferable because the locked state of the temporary account can be identified by the two parties to the transaction, and the on-line shopping process can be performed smoothly.

In addition, the server further comprises: an account money transfer unit for moving the money held in the temporary account based on a change in the locked state obtained by the temporary account locking unit, and on a request received from the purchaser or the vendor. In this manner, the on-line movement of money can be easily and safely performed.

According to an additional aspect of the invention, a server, which performs the functions of an on-line bank for a transaction entered into by a purchaser and a vendor connected via a network, comprises: temporary account generation means for generating a temporary, dedicated account for a transaction; transmission means for transmitting, via the network, the contents of the temporary account to the purchaser and the vendor; and reception means for receiving, from the purchaser via the network, an instruction directing the locking of the temporary account to inhibit access without permission by the vendor, and for receiving, from the vendor via the network, an instruction directing the locking of the temporary account to inhibit access without permission by the purchaser. Since the two parties alternately lock the temporary account, the business transaction can be completed with the security of the operation being ensured by the money, and the performance of an on-line shopping transaction, for which security is generally not ensured, can be easily and safely performed.

The transmission means can transmit, to the purchaser and to the vendor via a network, a result received by the reception means, together with the contents of the temporary account. Thus, a transaction can be performed while both the purchaser and the vendor can identify the contents.

When the temporary account has not been locked by the vendor, the reception means accepts, from the purchaser, a request to move the money in the temporary account. And when the temporary account has not been locked by the purchaser, the reception means accepts, from the vendor, a request to move the money in the temporary account.

According to the present invention, a vendor terminal, which performs an on-line transaction with a user, comprises: display means for receiving and displaying the contents of an account used for the transaction; and locking means for, based on the contents of the account displayed by the display means, locking the account in order to inhibit the performance, without permission, of a procedure by the user. The display means receives and displays the contents of the account, together with the state of the account after the account has been locked by the purchaser, in order to inhibit the performance, without permission, of a procedure by another party. This configuration is preferable because an access of the account of a user, who is a purchaser, can be detected by the vendor terminal, and a smooth transaction can be performed.

### BRIEF DESCRIPTION OF THE DRAWINGS

The foregoing aspects and other features of the present invention are explained in the following description, taken in connection with the accompanying drawings, wherein:

FIG. 1 is a system configuration according to the described embodiment of the invention.

FIG. 2 is a block diagram showing the arrangement used for a bank 12 that serves as a web server.

FIG. 3 shows the general processing performed by the system configuration according to the embodiment.

FIG. 4 is a flowchart showing the processing performed from the time a temporary account 50 is generated until it is erased.

FIG. 5 is a flowchart showing the processing performed upon the receipt of a request to move money into the temporary account 50.

FIG. 6 is an example of a log-in screen for Internet banking.

FIG. 7 is an example of a screen which is displayed when the log-in is successful.

FIG. 8 is an example of a screen used when generating the temporary account 50.

FIG. 9 is an example of a screen representing the state of the temporary account 50.

FIG. 10 is a screen for an account list when the temporary account 50 is established.

FIG. 11 is a table which explains the state of the data for the temporary account 50 stored in an account listing storage unit 22 in FIG. 2.

### DETAILED DESCRIPTION OF THE PREFERRED EMBODIMENT

The preferred embodiment of the present invention will now be described in detail while referring to the accompanying drawings.

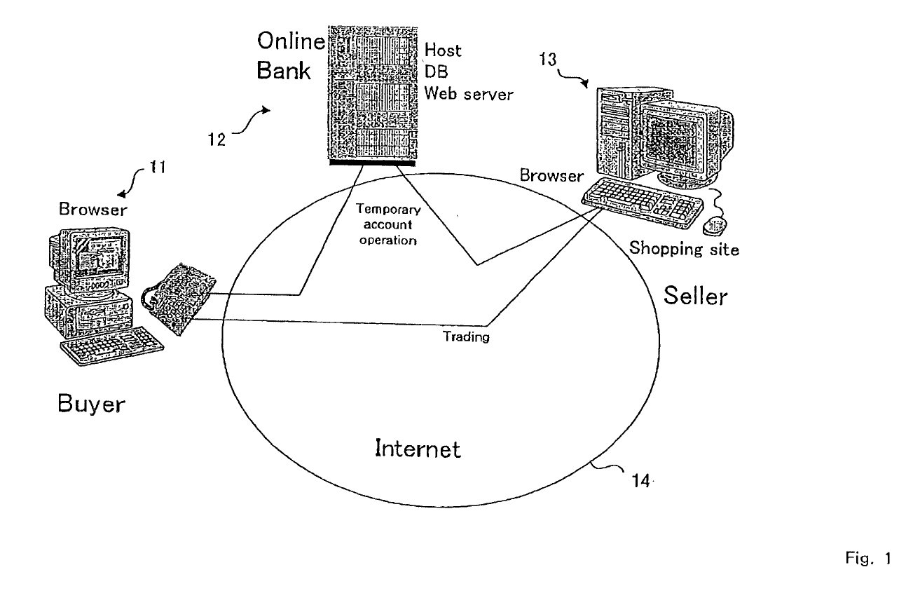

FIG. 1 is a diagram of a possible system configuration according to the invention. A user (Buyer) 11 is a consumer (purchaser) who desires to buy goods. The term “goods” may include the purchase of a single item. A financial institution (Bank) 12 is an on-line bank that holds an account for the user 11 and that serves as a web server for the system of this embodiment. A vender (Seller) 13 is an on-line shopping site that may be tied to or associate with the financial institution 12 that provides a service. The user 11 and the seller 13, which are web terminals, and the financial institution 12, which is a web server, are connected to a network 14, such as the Internet. Here, the user 11 can be regarded as a first user, and the seller 13 can be regarded as a second user.

The terminals of the user 11 and the seller 13 are PCs in which software, including a web browser, is stored that enables the user 11 and the seller 13 to communicate with each other using e-mail, to read the homepage of the bank 12, and to display account information that is received. The terminals of the user 11 and the seller 13 also include input means, such as a pointing device or a keyboard, for instructing the generation of a temporary account or the entry of a money value.

In this embodiment, the concept of an account (Account), which is temporarily established by the bank 12, is employed as a transaction method for an electronic commercial activity engaged in by the user 11 and the seller 13 via the network 14. A locking mechanism is provided that can be operated by both the user 11 and the seller 13, and that can lock the temporary account, to prevent access without permission, and can thus provide a safe transaction means for both the user 11 and the seller 13.

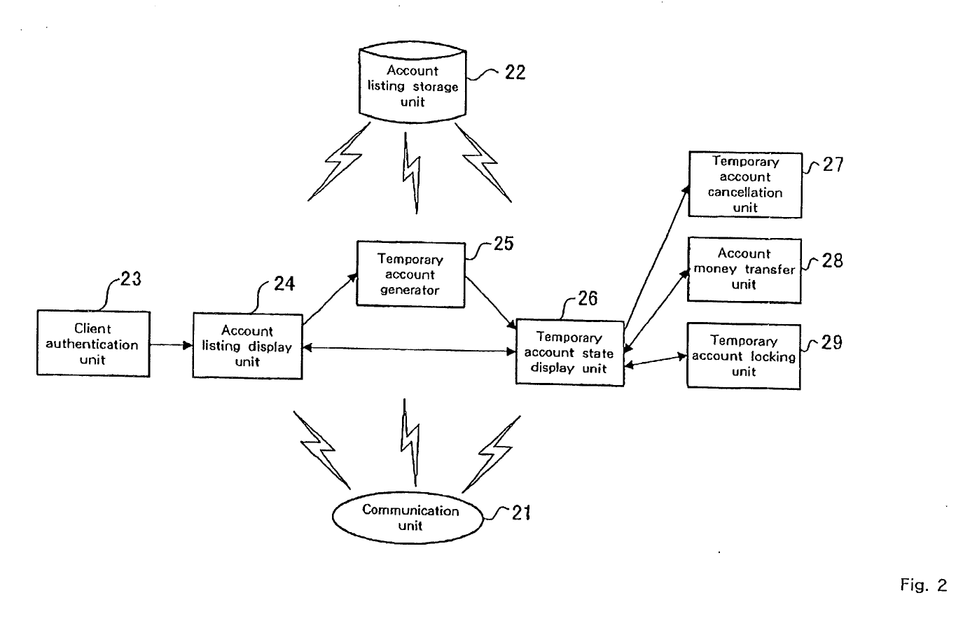

FIG. 2 is a block diagram illustrating the configuration of the bank 12, which is a web server. In FIG. 2, a communication unit 21 employs HTTP to exchange data via the network 14 with a web terminal, and can, for example, receive a request for the establishment of a temporary account or for the receipt of the contents of a payment, or can receive lock information from the user 11 and the seller 13. The bank 12 transmits, to each terminal, its web page, with which the setting of a temporary account can be achieved. An account listing storage unit 22 is a database for holding the states (a client, a balance and a type) of all the accounts, including the temporary account, in the bank 12. The communication unit 21 and the account listing storage unit 22 exchange data with all the other blocks in FIG. 2.

The web server of the bank 12 includes: a client authentication unit 23, for verifying the logging-in of a client using a user ID and a password; an account listing display unit 24, for displaying a list of client accounts; a temporary account generator 25, for generating a temporary account upon the receipt of a request from the client; a temporary account state display unit 26, for displaying the balance of the account, the user IDs of the user 11 and the seller 13 and their locked states; a temporary account cancellation unit 27, for canceling the temporary account that was established; an account money transfer unit 28, for transferring the money held in the temporary account to another account or to an ATM (a withdrawal), or for depositing money in the account; and a temporary account locking unit 29, for changing the locked state of the temporary account. For example, in the operation performed for the temporary account, the account money transfer unit 28 examines the locked state displayed by the temporary account state display unit 26.

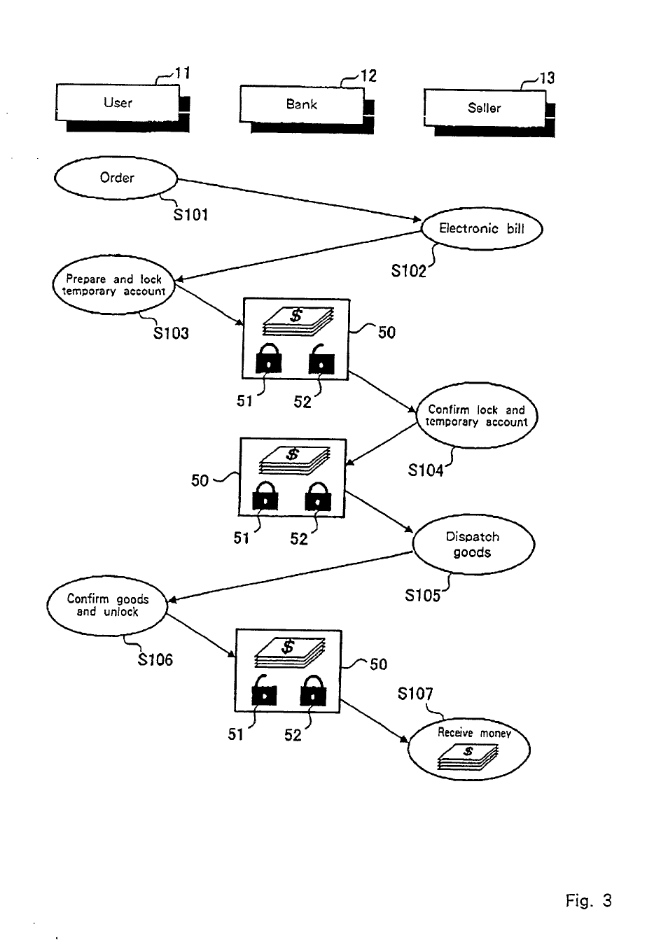

FIG. 3 illustrates the overall processing performed for the system configuration of this embodiment. In FIG. 3, a business transaction is shown for the activities performed by the user 11, who is a purchaser, the bank 12 and the seller 13. First, a user 11 issues an order to the seller 13 (step 101). This order may be issued by accessing the homepage of the seller 13 via the Internet and by depressing a “purchase” button, or by using a telephone, as in a conventional case. Upon the receipt of this order, the seller 13 transmits an electronic bill to the user 11 (step 102). The electronic bill can, for example, include the payment address, the contact address and the money due, and is encrypted using a conventional “public key”, so that even though the user 11 can read the bill, he or she can not alter it.

Upon the receipt of the electronic bill, the user 11 either submits the bill to the bank 12, or enters required data items, requests the generation of a temporary account 50 and locks the temporary account 50 (step 103). The temporary account 50 is an account that holds only a required amount of money, and that can be used on line to transfer the money to a fixed destination (the seller 13 in this case). When the electronic bill is submitted to the bank 12 and the request for the generation of the temporary account 50 is received, the bank 12, for example, transfers the money from the regular account of the user 11 in the bank 12 to generate the temporary account 50. If the user 11 does not have a regular account in the bank 12, the temporary account 50 can be opened upon the receipt of money from the user 11. The bank 12 transmits the access right and information for the temporary account 50 to the seller 13 and the user 11 addressed in the electronic bill. At this time, the money involved in the transaction is held in the temporary account 50, and is locked by employing a user's lock 51, but not a seller's lock 52. The user's lock 51 is employed to prevent any unauthorized access by the seller 13, and can be removed only by the user 11.

Upon the receipt of the notification from the bank 12, the seller 13 uses the seller's lock 52 to lock the designated temporary account 50 and confirms its contents (step 104). Thus, the money held in the temporary account 50 is secured, and currently, neither the user 11 nor the seller 13 can transfer the money. That is, the temporary account 50 is locked by the user's lock 51 and the seller's lock 52, and neither the user 11 nor the seller 13 can move the money. At this time, the seller 13 can safely ship the goods (step 105).

Upon the receipt of the goods, the user 11 confirms the contents and releases user's lock 51 on the temporary account 50 (step 106). Then, to receive the money, the seller 13 can transfer the money in the temporary account 50 to his or her own account (step 107). After this processing, the temporary account 50 is invalid, and no more money is transferred.

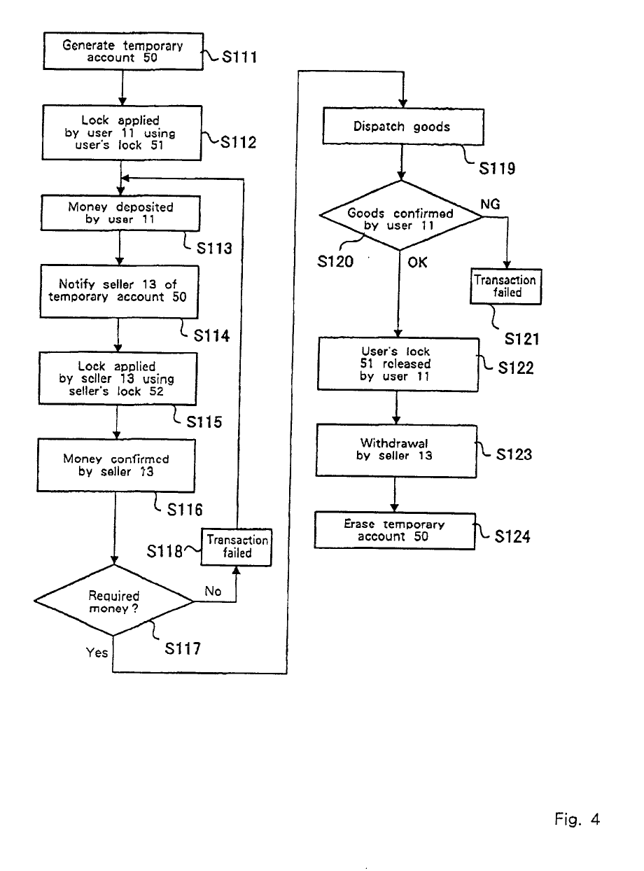

FIG. 4 is a flowchart showing the processing from the generation to the erasing of the temporary account 50. After the temporary account 50 has been generated (step 111), the user 11 uses the user's lock 51 to lock the temporary account 50 (step 112). When the user deposits the money (step 113) or transfers the money to the temporary account 50, the seller 13 receives a notification indicating the existence of the temporary account 50 (step 114). The seller 13 then uses the seller's lock 52 to lock the temporary account 50 (step 115), and confirms the money value (step 116). At this time, as the seller 13 can use the seller's lock 52 to lock the temporary account 50 after having confirmed the amount of money, a check is performed to determine whether the required money value is held in the temporary account 50 (step 117). If the money is not as much as is required, the transaction fails (step 118), and a notification to that effect is transmitted to the user 11. Program control thereafter returns to step 113 to wait for the user 11 to perform a money transfer. But if the required money is present in the temporary account 50, the seller 13 dispatches the goods (step 119). Then, if the user 11 confirms the receipt of the goods (step 120) but is not satisfied with it, the transaction fails (step 121). However, if the user 11 is satisfied with the goods, the user 11 releases the user's lock 51 on the temporary account 50 (step 122), thereby permitting the seller 13 to withdraw the money from the temporary account 50 (step 123), which is then transferred to the regular account of the seller 13. Thereafter, the temporary account 50 is erased (step 124).

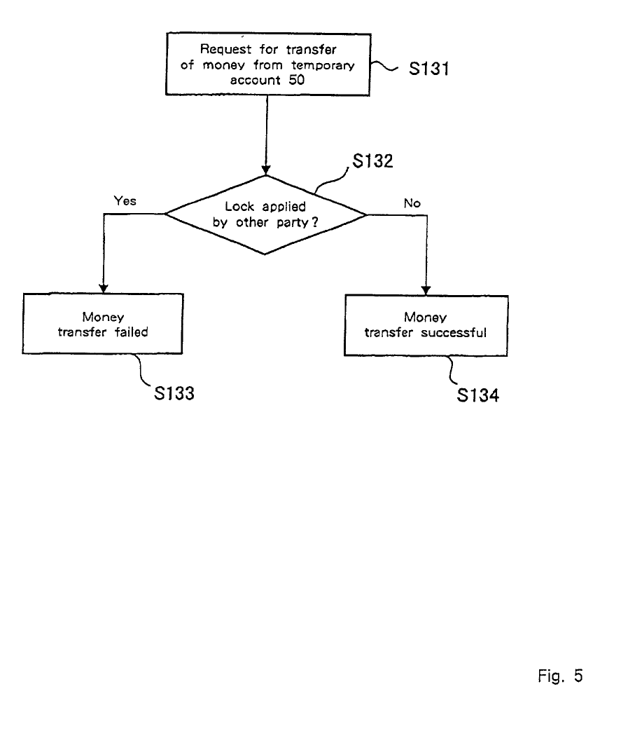

FIG. 5 is a flowchart showing the processing performed upon the receipt of a request to transfer the money from the temporary account 50. When the transfer of money held in the temporary account 50 is requested (step 131), the temporary account 50 is examined to determine the presence/absence of a lock by the other party (step 132). That is, the seller 13 can not move the money unless the user's lock 51 on the temporary account 50 has been released, while the user 11 can not move the money unless the seller's lock on the account 50 has been released. Thus, if a lock has been placed on the temporary account 50 by an opposing party, the transfer of money will fail (step 133). Whereas if a lock has not been placed on the temporary account 50 by an opposing party, the transfer of money will be successful (step 134). In this embodiment, by employing this function for the temporary account 50, the user 11 and the seller 13 can perform a safe electronic commerce transaction while ensuring the security of the money.

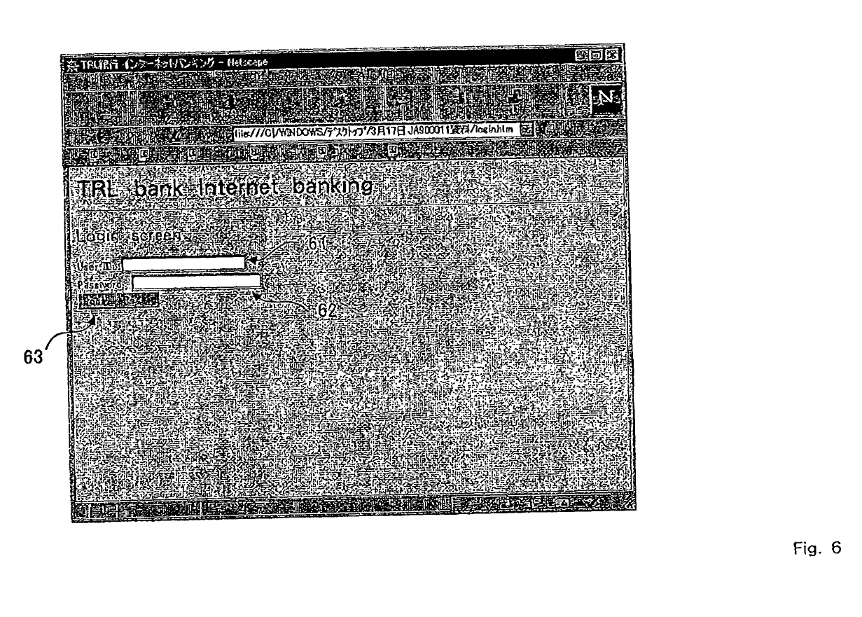

The processing performed by this system will now be described by using the example screens shown in FIGS. 6 through 10. These output screens can be displayed on the display means of the user 11 and the seller 13.

FIG. 6 is an example of a screen for log-in for Internet banking. In FIG. 6, a user 11 accesses the Internet banking process provided by the TRL bank, and a log-in screen is displayed. Then, the user 11, who desires to log in, enters a user ID 61 and a password 62, which, for Internet banking, are registered at the bank 12, and depresses a log-in key 63.

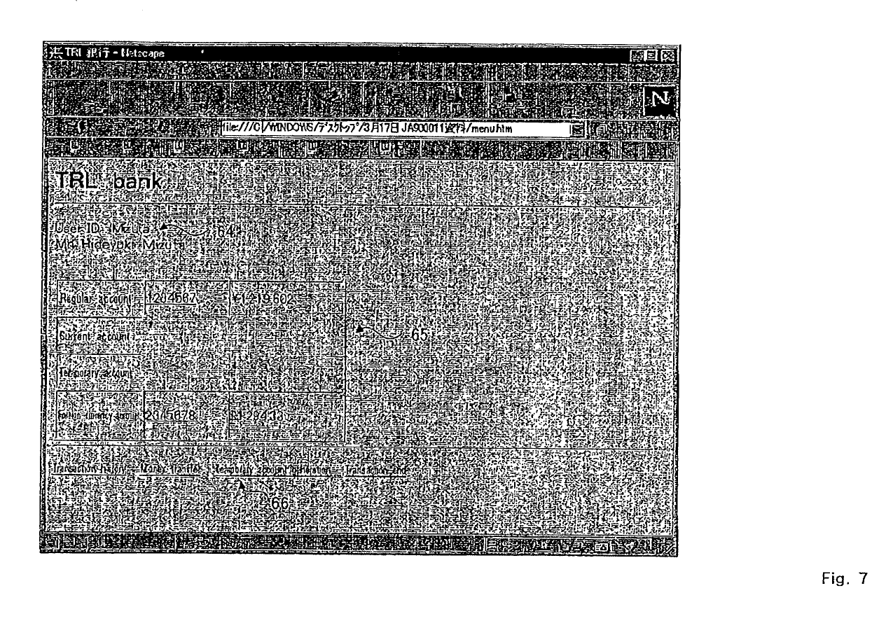

FIG. 7 shows an example of a screen when the log-in is successful. In FIG. 7, a successful user ID 64 is displayed, and an account list 65 for “Mr. Mizuta”, who is the current user 11, is also displayed. Then, when the user 11 desires to access a temporary account 50, the user 11 selects a temporary account generation link 66 from the link entries at the bottom. Using this operation, the instructions for the generation of the temporary account 50 can be transmitted to the bank 12.

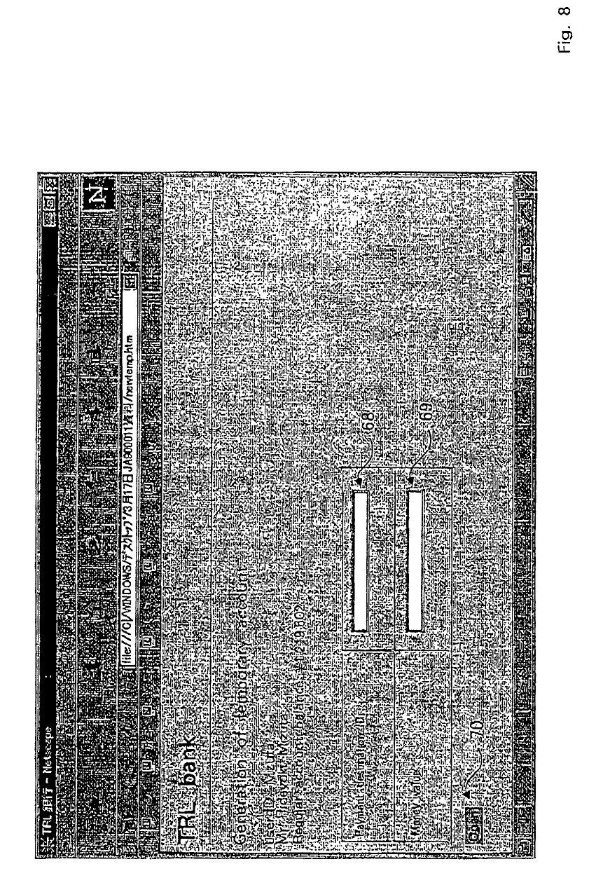

FIG. 8 shows an example screen for the generation of the temporary account 50. The user 11 enters the ID (payment destination ID) 68 of the seller 13 to whom the money is to be transferred, and a money value 69. Then, when the user 11 clicks on an “open” button 70, the temporary account 50 is generated.

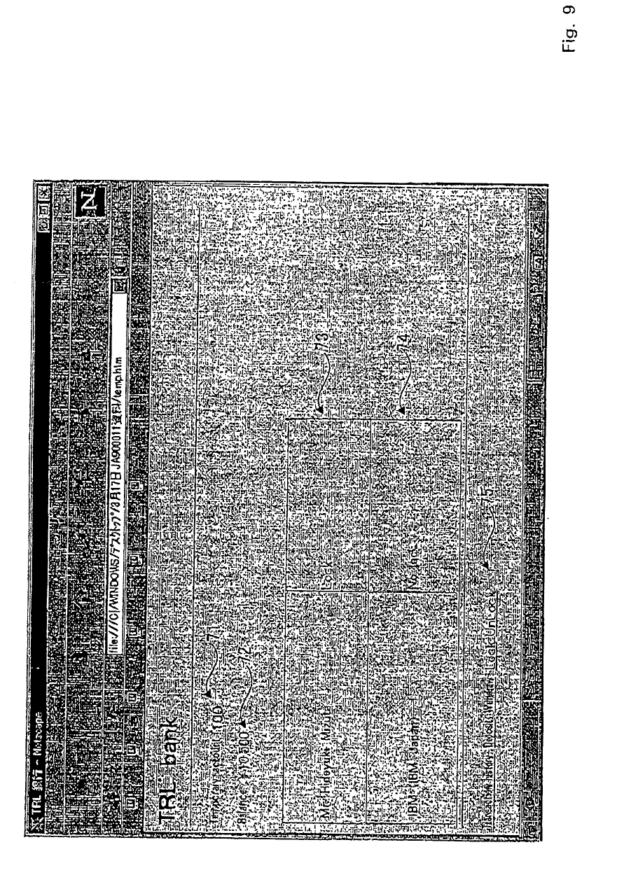

FIG. 9 shows the state of the thus generated temporary account 50. A number 71 for the temporary account 50, and a balance 72 are displayed, as are a state 73 for the user 11 and a state 74 for the seller 13. The state of the temporary account 50 can also be displayed on the terminals of both the user 11 and the seller 13. The state 73 of the user 11 indicates that the user's lock 51 has been employed, and that the seller's lock 52 has not been used. Since this state has been identified, the user 11 and the seller 13 can at any time obtain the state of the temporary account 50. The user 11 and the seller 13 can also designate the deposit of money, the withdrawal of money, and the locking and unlocking of the temporary account 50 using a link 75 at the bottom of the screen. For example, when “Mr. Mizuta”, who is the user 11, desires to release the user's lock 51 on the temporary account 50, he need only click on the “unlock” selection in the link 75. And when “IBM (IBM, Japan)” clicks on the lock in the link 75, the seller's lock 52 can be applied to the temporary account 50.

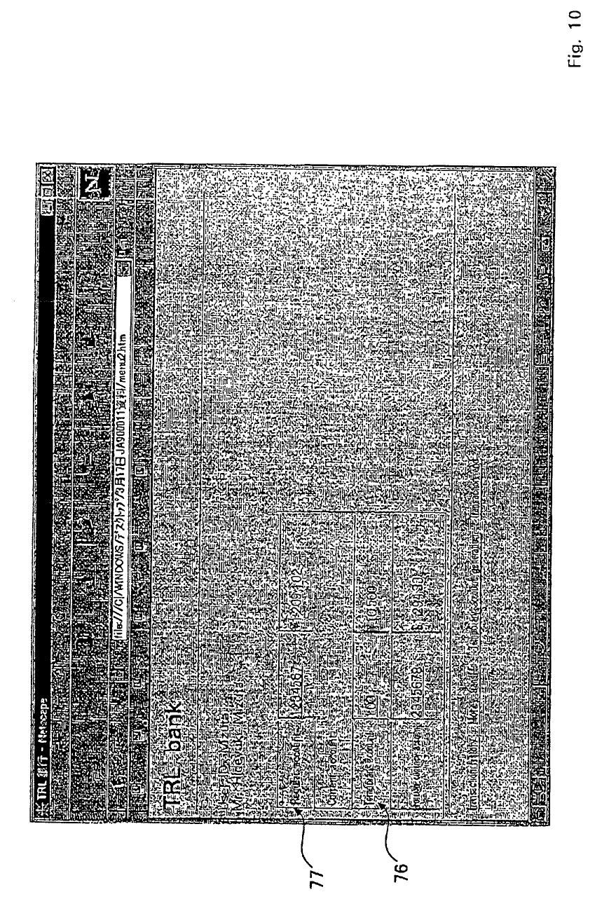

FIG. 10 is a figure showing an account list screen when the temporary account 50 is generated. The only differences between FIG. 7 and FIG. 10 are that the contents of the temporary account 50 are displayed in a temporary account column 76, and that a balance in a regular account column 77 is reduced by the equivalent of the amount of the money transferred to the temporary account 50. On the account list screen, the user 11 can confirm the contents in all the accounts, and the contents of the temporary account 50.

An explanation will now be given for the contents in the database held by the bank 12 in FIG. 2.

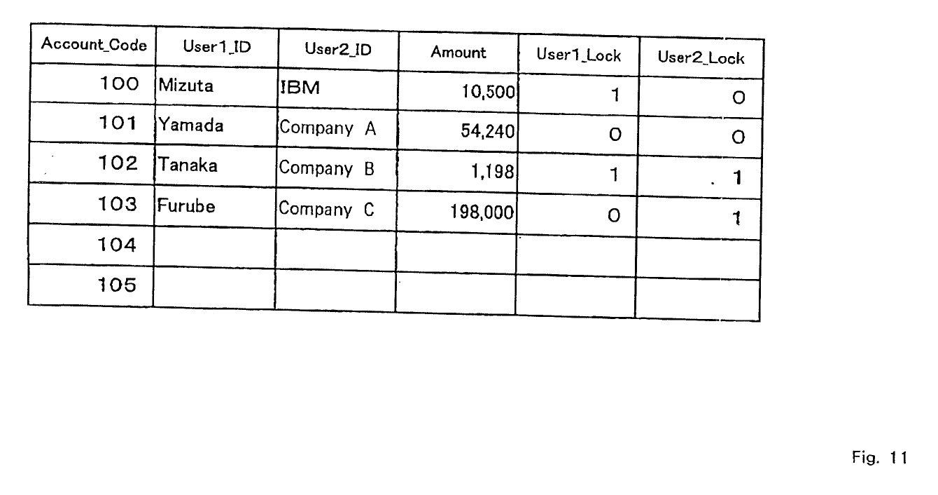

FIG. 11 is a table for explaining the state of data for the temporary account 50 that is stored in the account listing storage unit 22 in FIG. 2. In the account listing storage unit 22, the contents of the temporary account 50 are stored as a data set, as shown in FIG. 11. For each temporary account 50, a temporary account code (Account_Code), which is an identification code, the ID (User1_ID) of a user 1 (user 11), the ID (User2_ID) of a user 2 (seller 13), an account balance (Amount), and the locked states (User1_Lock and User2_Lock) of the users 1 and 2 are stored.

When the first entry is loaded into an object “ta”, the member variables are:

int ta.Account_Code=100

String ta.User1_ID=“Mizutal”

String ta.User2_ID=“IBM”

int ta.Amount=10500

int ta.User1_Lock=1

int ta.User2_Lock=0

The Account_Code is code with which, during the generation of the temporary account 50, the bank 12 can specify a unique account that is not overlapped by another. User1_ID is the ID of the user who opens the temporary account 50, and User2_ID and the balance (Amount) designated by the pertinent user are established. The Lock is set to a predetermined value (the lock of User1 is valid and the lock of User2 is invalid) when the temporary account 50 is opened.

When the lock of the other user is invalid (0), the user of the temporary account 50 can transfer money from the account 50 to his or her different account (can transfer or cash in the money). In this example, since User2_Lock=0, “Mizuta”, who is User1, can withdraw 10500 yen. However, since User1_Lock=1, “IBM”, which is User2, can not withdraw any money. As previously described, a user can freely change his or her own lock (Lock). For example, when User1 instructs that the lock be removed, the lock ta.Userl_Lock is changed from 1 to 0.

As another data form example, when the setting by User1_Lock and User2_Lock of an arbitrary real number of from 0 to 1, but excluding 0 and 1, is permitted, only a specific ratio of a money value can be locked. In this case, the temporary account 50 is not erased each time a transaction is completed, but instead, the account 50 is erased when all the money has been removed from it. Further, users involved in the transaction may be increased to three or more, and the condition for the withdrawal of money from the temporary account 50 may be based on a logical calculation (e.g., a logical product) performed for the locked state of all the users but oneself, or a specific group. In the above explanation, the temporary account 50 is opened by the user 11. However, the temporary account 50 may be generated by the seller 13, so that the user 11 can transfer money thereto.

As is described above in detail, according to a preferred embodiment, the temporary account 50, which is a dedicated account set up to pay for a purchase, is opened as one of the on-line banking functions, and both the user 11 (buyer) and the seller 13 (vender) can place a lock on it (the user's lock 51 and the seller's lock 52). As a result, a safe payment means can be provided whereby the money is held as security. The user 11 does not have to release the user's lock 51 until he or she has confirmed the correct goods have been received. If the user 11 does not like the goods that have been received, he or she can hold the money by not removing the lock on the temporary account 50. The seller 13, in turn, can ensure the money is held as security in the temporary account 50 by applying the seller's lock 52, and can thereafter forward goods with the assurance that a confirmed sale has been made. Further, if the temporary account 50 is opened in a reliable bank 12, the security that is provided can be even greater.

As its income for providing the services described in this embodiment, the bank 12 charges a commission fee that is either withdrawn from the regular bank account of the user 11 during the generation of the temporary account 50, or that is withheld from the money that is transferred to the seller 13.

In the described embodiment, an explanation has been given for a business transaction entered into by the user 11 and the seller 13 for the sale of a goods. However, from the viewpoint of the acquisition of money to be used as security, which is essential for a safe transaction, the present invention can be applied not only for trade, but also for a simple money transfer or for rental service.

As is described above, according to the present invention, a money transfer system can be provided that ensures a consumer and a vendor can safely enter into a business transaction, involving a predetermined amount of money, by applying procedures similar to those which are employed for an on-line money transfer.

What is claimed is:

1. An on-line transaction system for the use, via a network, of a vender and a purchaser of goods, to pay for goods said purchaser requests, comprising
first apparatus for establishing a temporary account for a designated transaction at a financial institution,
second apparatus for generating an instruction to deposit money in said temporary account issued by said purchaser,
third apparatus for providing a lock for said temporary account to limit access by said vendor; and
fourth apparatus for providing a verification by said vendor, via said network, which verifies the contents of said temporary account and locks said temporary account to limit access by said purchaser.

2. The on-line transaction system according to claim 1, wherein said vender, after locking said temporary account to limit access by said purchaser, then ships said goods.

3. The on-line transaction system according to claim 1, wherein, when said vender has verified that said temporary account has been unlocked by said purchaser, said vender moves said money deposited in said temporary account.

4. An on-line shopping transaction method, which is employed via a network by the vendor and the purchaser of goods, comprising:
said purchaser employing a first key, which is held at a financial institution and which only said purchaser can access, to place a first lock on money held by said financial institution for purchasing said goods;
said vendor employing a second key, which is held at said financial institution and which only said vendor can access, to place a second lock on said money; and
when said first key is employed to place a first lock on said money said vendor can not move said money and when said second key is employed to place a second lock on said money said purchaser can not move said money.

5. The on-line shopping transaction method according to claim 4, whereby said money held by said financial institution is deposited in a temporary, dedicated account opened for the remittance of a payment, and said first key and said second key are employed to lock said temporary account.

6. The on-line shopping transaction method according to claim 5, wherein said financial institution transmits a setup screen for a temporary account to said purchaser, and, in accordance with said setup screen; wherein said purchaser transfers money, for a business transaction, for deposit in said temporary account, issues a request to said financial institution to set up said temporary account, and as needed, transmits a request to said financial institution to use said first key to place a lock on said temporary account; and wherein said financial institution transmits a setup screen for said temporary account to said vendor, and receives from said vendor a request to use said second key to place a lock on said temporary account as needed.

7. The on-line shopping transaction method according to claim 4, wherein said vendor, after using said second key to place a lock on said money, ships goods to said purchaser; and wherein said purchaser uses said first key to remove said first lock on said money in order to pay said vendor.

8. An on-line shopping transaction method, which is employed by a vender and a purchaser via a network, comprising the steps of:
preparing a temporary account, designated for a transaction, upon the receipt of an on-line instruction from said purchaser;
receiving an on-line instruction from said purchaser to deposit money in said temporary account;
moving said money from said temporary account upon receipt of an on-line instruction from said vender; and
automatically erasing said temporary account after said money has been moved.

9. The on-line shopping transaction method according to claim 8, wherein said temporary account is locked on-line by said purchaser using a key therefor, and said temporary account is also locked on-line by said vendor using a key therefor; and wherein, when said temporary account is locked using said key belonging to said purchaser, money held in said temporary account can not be moved by said vendor, and when said temporary account is locked using said key belonging to said vendor, money held in said temporary account can not be moved by said purchaser.

10. A server, which is connected to a network and which serves as an on-line bank for on-line shopping transactions, comprising:
a reception unit for receiving a request, from a terminal of a purchaser connected to said network, for the preparation of a temporary account used for an on-line shopping payment, and for receiving information concerning money that should be deposited in said temporary account;
a temporary account generator for generating said temporary account based on said request and on said money information that is received;
a storage unit for storing information concerning said temporary account;
a key information reception unit for receiving, from said terminal of said purchaser, purchaser key information for the inhibition of the transfer of money in said temporary account by a party other than said purchaser, and for receiving, from a terminal of a vendor connected to said network, vendor key information for the inhibition of the transfer of money in said temporary account by a party other than said vendor; and
a temporary account locking unit for employing said purchaser key information and said vendor key information to change information, stored in said storage unit, concerning the locked state of said temporary account.

11. The server according to claim 10, further comprising:
a transmission unit for storing in said storage unit, in addition to said information concerning said temporary account, a change in said state of said temporary account for which a lock is applied by said temporary account locking unit, and for transmitting said information stored in said storage unit for said temporary account.

12. The server according to claim 10, further comprising:
an account money transfer unit for moving said money held in said temporary account based on a change in said locked state obtained by said temporary account locking unit, and on a request received from said purchaser or said vendor.

13. A server, which performs the functions of an on-line bank for a transaction entered into by a purchaser and a vendor connected via a network, comprising:
a temporary account generator for generating a temporary, dedicated account for a transaction;
a transmission unit for transmitting, via said network, the contents of said temporary account to said purchaser and said vendor; and
a reception unit for receiving, from said purchaser via said network, an instruction directing the locking of said temporary account to inhibit access without permission by said vendor, and for receiving, from said vendor via said network, an instruction directing the locking of said temporary account to inhibit access without permission by said purchaser.

14. The server according to claim 13, wherein said transmission unit transmits, to said purchaser and to said vendor via a network, a result received by said reception unit, together with the contents of said temporary account.

15. The server according to claim 13, wherein, when said temporary account has not been locked by said vendor, said reception unit accepts, from said purchaser, a request to move said money in said temporary account; and wherein, when said temporary account has not been locked by said purchaser, said reception unit accepts, from said vendor, a request to move said money in said temporary account.

16. A vendor terminal, which performs an on-line transaction with a user, comprising:
a display for receiving and displaying the contents of an account used for said transaction; and
a lock for, based on the contents of said account displayed by said display, locking said account in order to inhibit the performance, without permission, of a procedure by said user.

17. The vendor terminal according to claim 16, wherein said display receives and displays the contents of said account, together with the state of said account after said account has been locked by said purchaser, in order to inhibit the performance, without permission, of a procedure by another party.

18. An on-line transaction system operated by a first user and a second user via a network, wherein to pay for goods said first user requests that a financial institution prepare a temporary account for a designated transaction, said first user issues an instruction to deposit money in said temporary account, and locks said temporary account to limit access by said second user; and wherein said second user, via said network, verifies the contents of said temporary account and locks said temporary account to limit access by said first user.
